(19) United States
(12) Patent Application Publication
(10) Pub. No.: US 2021/0300788 A1
(43) Pub. Date: Sep. 30, 2021

(54) ATMOSPHERIC WATER AND POWER GENERATION COMPRESSION APPARATUS, SYSTEM AND METHOD

(71) Applicant: CHAAC Holdings, Inc., Woodstock, MD (US)

(72) Inventors: Orlin Wetzker, South Ogden, UT (US); Miranda Wetzker, South Ogden, UT (US)

(73) Assignee: CHAAC Holdings, Inc., Woodstock, MD (US)

(21) Appl. No.: 17/213,698

(22) Filed: Mar. 26, 2021

Related U.S. Application Data
(60) Provisional application No. 63/001,380, filed on Mar. 29, 2020.

(51) Int. Cl. C02F 1/04; C02F 1/14

(52) U.S. Cl. CPC C02F 1/041; C02F 1/043; C02F 1/14

(57) ABSTRACT

The invention is an apparatus, system and method for the generation of usable water from atmospheric water vapor and the generation of electric power and compressed air from and for such system.

### CROSS REFERENCE TO RELATED APPLICATIONS

This application claims the benefit of U.S. Provisional Patent Application No. 63/001,380 filed on Mar. 29, 2020 “Atmospheric Water and Power Generation Compression Apparatus, System and Method,” which application is incorporated herein by reference in its entirety.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is an apparatus, system and method for the generation of usable water from atmospheric water vapor, the generation of electricity, and compressed air from and for such system.

### Background of the Invention

Dehumidifying technology was pioneered in an effort to keep indoor humidity levels low, primarily for comfort and reduction in housing/commercial structures. Within geographic areas of high humidity, the technology will convert said humidity into water through condensation. With the inclusion of filtering devices, the same technology has become known as atmospheric water generation (AWG).

As with any powered device located in a remote or isolated area, power generation is a key problem to be addressed. Currently remote electrical generation is achieved via an input of fuel, such as diesel, gasoline, or solar, which drives a motor that creates electrical power.

Compressed air is arguably the earliest form of power and continues to be used as a source of easily storable power for a variety of applications. Compression is also the basis for many techniques for the separation of inert gases from air. Furthermore, once air is compressed, particulates may be removed or separated to include pollutants and contaminates. Many facilities use forced air systems such for heating, ventilation, and air condition (HVAC).

The invention as described and claimed herein is a method can be achieved that creates electrical power, water, and compressed air using heat energy as the motive force. The outputs may be redirected back into the system or used in a variety of applications. The invention is intended for multiple purposes, to include but not limited to, environment rejuvenation via on-site atmospheric water reclamation technology, converting humid deserts into vegetated landscapes, generating clean water for human consumption, planetary terraforming and the creation of an artificial water vapor resupply cycle, specifically an augmentation of photosynthesis.

When used in a specified environment such as a greenhouse or other location, the disclosed system will be capable of removing water vapor from the air, condensing the vapor, and forcefully distributing the condensed atmospheric water vapor into soils to hydrate plants, then repeat the process once the water is reintroduced into the atmosphere. The clean, dry air may also be used for recirculation or environmental control.

Atmospheric water vapor represents a native supply of water to rejuvenate agricultural and human requirements, even in remote and arid climates. With the use of water distillation or activated carbon filtering, AWG devices can provide a source of natural and safe drinking water within areas of high to moderate humidity. Generally, dehumidifiers output water via a condensation drip into a water receptacle, thus collecting metallic and chemical elements to render the collected water unsafe for drinking. In particular, by using water distillation, and then adding minerals that are needed for human health, drinking water would be safer for human consumption.

One deficiency of many AWG systems is a reliance on warm ambient air to allow for efficient dehumidification. By using one or more powered air compressors combined with intercoolers or other types of heat exchanges, it is possible to create a system highly efficient in its heat conservation, thus requiring less power to effect condensation. Such a system, using the pressure from such compressors, may also be efficient in capturing and recycling the kinetic energy of pumping air and water to generate electrical power.

Another deficiency with known AWG systems is low production rates. The use of fans and refrigerant cooling alone create production limits, as air flow must be restricted to a relatively low rate to enable efficient dehumidification.

Known AWG systems fail to combine features of self-generating power with high-level water generation, transportation and purification means feasible for an airborne environment. Such known systems also tend to be inefficient in retaining heat, thus requiring additional power to effect water condensation. Applicant's claimed system and methods achieve these objectives for power generation and heat retention for increased efficiency in condensing and harvesting atmospheric water vapor.

### BRIEF SUMMARY OF THE INVENTION

In a preferred embodiment, the atmospheric water and power generation apparatus will have a fuel (power) input such as concentrated solar power (CSP), natural gas, solar panels, diesel, hydrogen, coal, etc which will produce heat or mechanical energy as the motive force. This power will be used to drive a turbine which will pull in and compress the air. During compression, the air will release water vapor which will be collected for various uses. The compressed air will flow into an electrical generator—preferably a bladeless centripetal flow turbine—which will generate electricity. The compressed air will then be distributed for various uses to include external or internal power. The system will recycle heat, electricity, and compressed air power to maximize the efficiency.

### BRIEF DESCRIPTION OF THE DRAWINGS

FIG. 1 is a flow chart evidencing an atmospheric water generation system and showing components thereof and the pathway of water and air through such system.

FIG. 2 is a flow chart showing placement of an electrical generator to provide power to various components.

FIG. 3 is a flow chart showing circulation patterns of the condensed water, as it is used to cool the compressed air between compression stages.

### DETAILED DESCRIPTION OF THE INVENTION

The invention as described and claimed herein is intended for the purposes of providing clean water, compressed air, and electrical power. This may be to areas where the transport of such utilities by pumping, piping, or generating is logistically or financially difficult. Uses include, but are not limited to, converting humid deserts into vegetated landscapes, generating clean water for human consumption, cloud-to-water conversion technology, making contained environments—such as greenhouses and distilleries—more efficient, planetary terraforming, and the creation of an artificial water vapor and power resupply cycle. In a particularly preferred method, electrical and compressed air power as well as water will be generated, using heat energy as the motive force. In a less preferred embodiment, water is repurposed into hydrostatic pressure to enable a native power supply to reduce external power consumption and maintenance requirements.

AWG technology can consume atmospheric water vapor and ice crystals through increasing the pressure of the air, using the action of one or more compressors to pull in moisture-rich atmospheric air for conversion. Once condensed, the water vapor precipitates and the resulting liquid water is captured and collected in a condensation tank or vessel. Water distillation for purification purposes will be employed once the condensed liquid water is collected. Alternatively, the methods of evaporator coils for condensation, air fans for air intake and filtration for purification may also be used.

### Definitions

An axial compressor is a type of gas compressor. It is a rotating, airfoil-based compressor in which the gas or working fluid principally flows parallel to the axis of rotation, or axially. This differs from other rotating compressors such as centrifugal compressor, axi-centrifugal compressors and mixed-flow compressors where the fluid flow will include a “radial component” through the compressor. The energy level of the fluid increases as it flows through the compressor due to the action of the rotor blades which exert a torque on the fluid. The stationary blades slow the fluid, converting the circumferential component of flow into pressure. Compressors are typically driven by an electric motor or a steam or a gas turbine. Axial flow compressors produce a continuous flow of compressed gas and have the benefits of high efficiency and large mass flow rate, particularly in relation to their size and cross-section. They do, however, require several rows of airfoils to achieve a large pressure rise, making them complex and expensive relative to other designs (e.g. centrifugal compressors).

Centrifugal compressors, sometimes called radial compressors, are a sub-class of dynamic axisymmetric work-absorbing turbomachinery. Centrifugal compressors achieve a pressure rise by adding kinetic energy/velocity to a continuous flow of fluid through the rotor or impeller. This kinetic energy is then converted to an increase in potential energy/static pressure by slowing the flow through a diffuser. The pressure rise in the impeller is in most cases almost equal to the rise in the diffuser.

An impeller is a powered rotor used to increase the pressure and flow of a fluid. It is the opposite of a turbine, which extracts energy from, and reduces the pressure, of a flowing fluid. An impeller is a rotating component of a centrifugal pump which transfers energy from the motor that drives the pump to the fluid being pumped by accelerating the fluid outwards from the center of rotation. The velocity achieved by the impeller transfers into pressure when the outward movement of the fluid is confined by the pump casing. An impeller is usually a short cylinder with an open inlet (called an eye) to accept incoming fluid, vanes to push the fluid radially, and a splined, keyed or threaded bore to accept a drive shaft.

An intercooler is a machine used to cool a gas after compression. Compressing a gas increases its internal energy which in turn raises its temperature and reduces its density. An intercooler typically takes the form of a heat exchanger that removes waste heat in from a gas compressor. Intercoolers have a variety of applications, and can be found in refrigerators, air conditioners, air compressors, gas turbines and automobile engines, for example. They are widely known as an air-to-air or air-to-liquid cooler for forced induction (turbocharged or supercharged) internal combustion engines used to improve volumetric efficiency. This is accomplished by increasing intake air density through nearly constant pressure cooling.

An inverter is an electronic device or circuitry that changes direct current to alternating current.

A Tesla turbine is a bladeless centripetal flow turbine patented by Nikola Tesla in 1913. It is sometimes referred to as a bladeless turbine, cohesion-type turbine, and Prandtl-layer turbine. It is also known as a boundary-layer turbine because it uses the boundary-layer effect and not a fluid impinging upon the blades as in a conventional turbine. Bioengineering researchers have referred to it as a multiple-disk centrifugal pump. A Tesla turbine consists of a set of smooth disks, with nozzles applying a moving fluid to the edge of the disk. The fluid drags on the disk by means of viscosity and the adhesion of the surface layer of the fluid. As the fluid slows and adds energy to the disks, it spirals into the center exhaust. The device can also serve as a pump if a similar set of disks and a housing with an involute shape are used.

To get to the saturation state, or dew point of atmospheric air, heat needs to be removed from the air in a continuous flowing stream. A continuous process will allow for larger volumes of air to be processed. First, air will be forced into a smaller volume which will increase the pressure and the temperature of the air. Second, the temperature of the compressed air will increase as the pressure increases. Third, the hot compressed air will be cooled by the lower temperature ambient air surrounding the pipe or vessel containing the compressed air. Fourth, a small decrease in the temperature of the compressed air will put the compressed air in a saturated state, allowing the water to be separated from the air. By following this process, the need for secondary refrigeration is eliminated, allowing for a large volume of air to be processed. This process is commonly observed in air compressors which will regularly need to drain water from the compressed air tank during operation. Water will be removed and drained by an air-water separator that will be placed immediately after the heat exchanger, thus obviating the need for direct drainage from the heat exchanger. Cyclonic flow of the moisture-rich air within the system will move the heavy water in the air to the walls of the vessel and be condensed and collected as liquid water.

The system is composed of four primary systems and additional supporting systems. The core system will include the following features: heat (power) input, power generation (mechanical work), air compression and water generation. Outputs from the system include: Water, Electrical Energy, Waste Heat and dry, clean air. The compressed air leaving the system will have significant reduction in any airborne particulates, making it breathable and suitable for population centers. As the compressed air is expanded it will also have a natural cooling effect to below ambient air temperatures, providing a potential source for building cooling. Additional features or benefits of the disclosed system could include heat collection, thermal energy storage, water distillation, sewage treatment, air processing, industrial processing, etc.

The system is designed to run on heat as the input energy source. The system is specified using CSP (Concentrated Solar Power) as that power source is abundant, requires no fuel cost and has no emissions. Other forms of heat would all be feasible with the core system including: natural gas, geothermal, biomass, hydrogen, coal, etc. Each heat source has its own list of pros and cons that will be specific to the location of the installed system.

The turbine may also be driven by more conventional power sources directed towards a mechanical engine which may turn the turbine.

This system will be most effective in locations where water shortage is a significant concern, with the added benefit of electrical power generation. This system may also be of significant benefit in areas that have a significant amount of air pollution, as it will process large volumes of air and exhaust clean air.

Conservation of heat is the primary driver of the overall efficiency of the system. Heat exchange will be utilized throughout the system to remove heat from one stream and give heat to another. For instance, the water that condenses through AWG will be used to cool the steam leaving the steam turbine, condensing the steam to liquid water. Utilizing heat in this manner will help in keeping the initial efficiency of the system high.

Turning to the functionality of the disclosed system, power will be generated by heating water in a boiler to create steam. Steam will then run through a steam turbine to generate the power needed by the rest of the system. The steam will then be recovered in a condensation tank which will then flow back into the boiler. Power generated by the turbine will used by the axial air compressor with the shaft of the turbine being shared by the air compressor. Optionally, the shaft will also be connected to an electrical generator to create electrical energy.

The primary system used for AWG will be to compress ambient air, remove heat from the compressed air, decompress the air so that it is saturated and then separate the water from the air. The air will be compressed using a multi staged axial air compressor raising the pressure to 7-8 atmospheres (100-150 psi). This will raise the temperature to around 180 deg C. Cooling the condensed air will move it to the saturation point and allow liquid water to be separated from the air.

Hot, compressed air will leave each air compressor stage and flow through an associated heat exchanger. The heat exchanger will transfer heat from the compressed air into a separate working fluid such as air or water. The cooling process will reduce the compressed air its saturation point, at which time the air will be forced through an air water separator. Liquid water will then be removed and ready to process in the next step.

Liquid water removed from the processed air can be processed in a number of ways depending on delivery requirements. Water can be stored local to the site in a standing reservoir. Water can be further processed to remove impurities through a distillation process by taking advantage of the waste heat generated in the primary AWG process. Water may also be used as a cooling medium for the compressed air, especially if the water is going through a distillation process.

Generating electrical power also can be the primary output of the total system in lieu of a mere secondary output. As the primary output the input heat would be sized for the target electrical output plus the AWG output. The system could run with either one or multiple steam generators to accommodate the output demands. As a secondary process, electrical generation would utilize additional power available from the primary turbine and additional power by putting turbines in the compressed air path as the air decompresses. Additional electrical generation may be possible by recovery of other waste heat within the system.

### DETAILED DESCRIPTION OF THE FIGURES

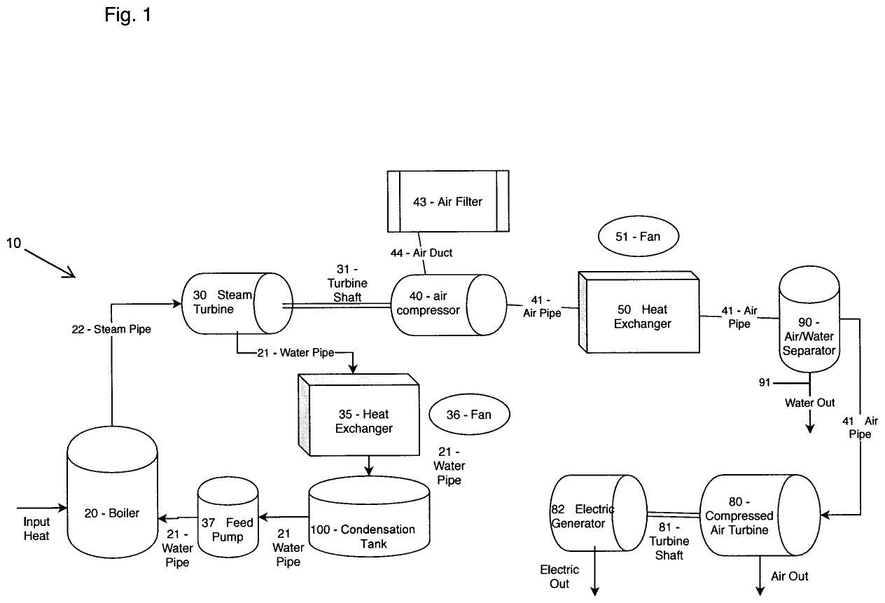

FIG. 1 is a flow chart evidencing the components and flow directions of a multi-compressor atmospheric water generation system 10. In FIG. 1, water is fed from a condensation tank 100 via water pipe 21 to a boiler 20, which generates steam which is released via an extension of steam pipe 22, wherein the steam is pressurized. The boiler 20 may be powered through any external source, including without limitation solar panels, generators, or the use of electric power generated by one of the turbines described herein below. The water pipe then conducts the pressurized steam to steam turbine 30, activating such turbine and turning turbine shaft 31. In a preferred embodiment, steam turbine 30 is either a standard impact turbine or a Tesla turbine.

The steam then exits the turbine via an extension of the steam pipe 21, is run through a first heat exchanger 35 and then is collected in condensation tank 100, condensing back into liquid water either in the pipe or tank. It should be noted that the circuit of water and steam from and back to the condensation tank is a closed cycle, with the only output being turning of the turbine shaft 31. Optionally, the steam turbine may also generate additional electric power to be stored in batteries to be recycled back into the AWG system or sold back to the local power grid.

Turbine shaft 31 extends from steam turbine 30 first to air compressor 40, where the shaft powers such compressor, which is preferably embodied as an axial air compressor with six to nine stages of axial compression. In an axial compressor, air flow is directed between a stator (stationary blade) and a rotor (rotating blade) to reduce the chamber volume as the air moves axially along the flow path. Multiple stages are required to prevent the flow from reversing along the flow path. Pictured adjacent to the first compressor is an air filter 43, which will remove solid particles captured in the air and allow atmospheric air into the compressor. As the air is compressed and its volume decreases, the temperature of the compressed air rises.

The compressed, heated air is then conducted through air pipe 41 to second heat exchanger 50, embodied as either layered piping 41, over which ambient air or liquid water is drawn, thus cooling the air within the pipe and heating the ambient air or water. Optionally heat may be removed from the compressed air by passing ambient air across tubes containing the compressed air using a fan to force ambient air. The increased temperature in the ambient air stream may be used in multiple cases such as building heating or to increase the water mass in the intake air stream.

The now-cooled air exits the second heat exchanger 50 through further air pipe 41 and is processed through an air water separator 90. The air water separator will use centrifugal force to precipitate water out of the saturated air. Liquid water will be drained via a vent 91 that will minimize loss of pressure in the now dry compressed air.

The dry compressed air will continue from the air water separator 90 through air pipe 41 to a compressed air turbine 80. The air turbine is preferably to be embodied as a Tesla (boundary-layer) turbine. Compressed air conducted through the air turbine will accelerate as it is allowed to expand, thus causing the turbine to generate electric power.

In an alternate embodiment, multiple stages of compression and heat exchange/condensation will be required. In other alternate embodiments, three or more such stages will be used to effect maximum efficiency of water condensation.

The target air pressure upon the air leaving the compressor will be 115 psi. The target air temperature upon the air leaving the first heat exchanger will be 180 C. The target air temperature upon the air leaving the first heat exchanger will be 150 C.

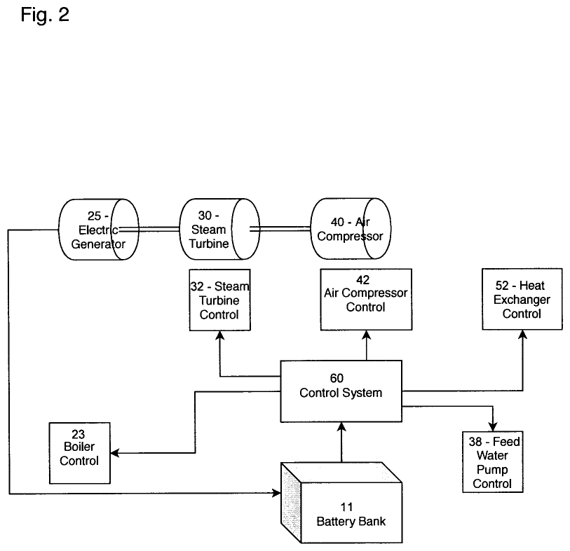

FIG. 2 is a flow chart showing placement of an electrical generator to provide power to various components. As pictured, a battery bank 11 powers an electric generator 25, which in turn powers the steam turbine 30 and air compressor 40. A control system 60 comprising at least one circuit board, is also powered by battery bank 11 and is connected, either by wire or by wireless communication with each of a steam turbine control 32, air compressor control 42, boiler control 23, heat exchanger control 52 and feed water pump control 38. The control system will monitor the status of each component via its respective control unit and communicate when adjustments are to be made to a given component via its associated control unit.

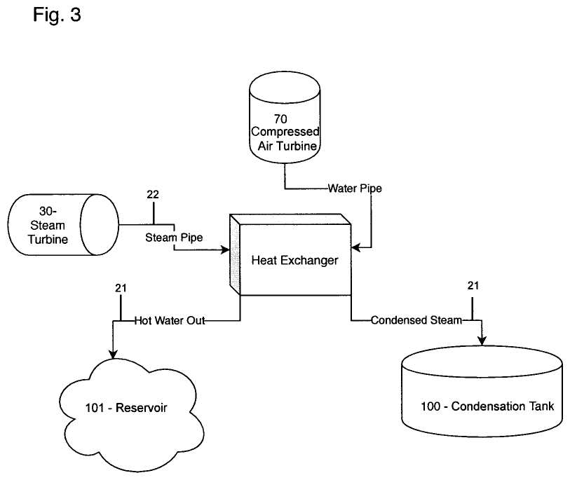

FIG. 3 is a flow chart showing circulation patterns of the condensed water, as it is used to cool the compressed air between compression stages. Both the steam leaving the steam turbine 30 via steam pipe 22 and water leaving the condenser 80 via water pipe 21 enter the heat exchanger. Upon such differentiation, the hot water drains from the heat exchanger through a water pipe 21 to a reservoir 101 for distillation or direct reuse as irrigation water. The condensed steam drains through a separate water pipe 21 to the feed water tank 100.

### INDEX OF PARTS

10 AWG system
11 Battery bank
20 Boiler (water heater)
21 Water pipe
22 Steam pipe
23 Boiler control
25 Electrical generator
30 Steam turbine
31 Turbine shaft
32 Steam turbine control
35 First heat exchanger
36 Fan
37 Feed water pump
38 Feed water pump control
40 Air compressor
41 Air pipe
42 Air compressor control
43 Air filter
44 Air Duct
50 Second heat exchanger
51 Fan
52 Heat exchanger control
60 Control system
82 Compressed air turbine
81 Turbine shaft
82 Electric Generator
90 Air/water separator (Condenser)
91 Vent
100 Condensation tank
101 Reservoir

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. An atmospheric water generation system, comprising a first and second closed circuit connected by a first turbine shaft, wherein the first closed circuit comprises:
a boiler,
a steam turbine,
a first heat exchanger, and
a condensation tank,
wherein water is pumped from the condensation tank to the boiler, converted to steam, the steam is conducted to the steam turbine, thus turning the first turbine shaft, and water condensed in the steam turbine exits the turbine through a water pipe and flows to the first heat exchanger for cooling and thereby drains to the condensation tank for re-circulation wherein the second closed circuit comprises:
an air compressor,
a second heat exchanger,
an air/water separator,
a compressed air turbine,
second turbine shaft,
electric generator, and
a reservoir,
wherein the first turbine shaft powers the air compressor, which intakes and compresses atmospheric air, compressed air is conducted to and cooled and partly dehumidified by the second heat exchanger, each of the compressed air and condensed water is then delivered via pipe to the air/water separator, wherein the air is further dehumidified, the separated condensed water is drained through a water pipe to the reservoir and the dehumidified compressed air is conducted to the compressed air turbine, thus turning the second turbine shaft and expelling the air through an air pipe into the atmosphere, wherein the second turbine shaft extends to and powers the electric generator, which generates electric power.

2. The atmospheric water generation system of claim 1, wherein the steam turbine is a standard impact steam turbine or a Tesla turbine.

3. The atmospheric water generation system of claim 1, wherein the air compressor is an axial compressor.

4. The atmospheric water generation system of claim 1, wherein the compressed air turbine is a Tesla turbine.

5. The atmospheric water generation system of claim 1, wherein the boiler, steam turbine, first heat exchanger and condensation tank comprise a closed power generation circuit.

6. The atmospheric water generation system of claim 1, wherein the boiler is powered with a combination of solar panels or a natural gas generator, together with electrical power generated from the steam and/or compressed air turbine.

7. The atmospheric water generation system of claim 1, wherein the condensation tank comprises a condensation chamber and a water reservoir chamber.

8. The atmospheric water generation system of claim 1, further comprising an air filter located in the air pipe before the air compressor.

10. The atmospheric water generation system of claim 1, wherein some water from the water reservoir chamber is recycled into the first heat exchanger.

11. The atmospheric water generation system of claim 1, wherein the first heat exchanger separates hot water from condensed steam, and drains the hot water to a reservoir for distillation and the condensed steam to the condensation tank for recirculation.

12. A method of atmospheric water generation, using the atmospheric water generation system of claim 1 comprising: filling the condensation tank with water, providing initial power to the boiler and heat exchangers from an external power supply, providing secondary power to all system components from one of steam turbine or compressed air turbine, and providing supplemental power to all system components from an external power supply as needed.

13. The method of claim 11, wherein the external power supply is one or more taken from the group consisting of: solar panels, windmills, a natural gas generator, a gasoline generator and a diesel generator.

14. A method of power generation using the atmospheric water generation system of claim 1, comprising: filling the condensation tank with water, providing initial power to the boiler and heat exchangers from an external power supply, generating electric power with the steam turbine and compressed air turbine and directing such generated electric power to one or more batteries or back into a local power grid.

15. The method of claim 13, wherein a percentage of the generated electric power is recycled to power the components of the atmospheric water generation system.
